(19) United States
(12) Patent Application Publication
(10) Pub. No.: US 2004/0045152 A1
(43) Pub. Date: Mar. 11, 2004

(54) Method of assembling a torque limiting device having a damper mechanism

(75) Inventor: Kozo Uno, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: Exedy Corporation

(21) Appl. No.: 10/642,247

(22) Filed: Aug. 18, 2003

(30) Foreign Application Priority Data
Sep. 5, 2002 (JP) 2002-259546

(51) Int. Cl. B23P 21/00

(52) U.S. Cl. 29/469

(57) ABSTRACT

A method for assembling a torque limiting device to be mounted to a member on the engine side is disclosed, the torque limiting device having a clutch plate 11 that includes a clutch disk 13, a spline hub 25 that has a spline hole 25a in the inner peripheral portion thereof, a damper mechanism 16 that links the clutch plate 11 and the spline hub 25 together, and a torque transmission controller 6 that is mounted to a flywheel 2, has friction facings 21 that are interposed between a pair of plates 30, 31, and which controls the torque transmitted thereby. This assembly method includes a first step in which the spline hub 25 and the torque transmission controller 6 are centered and attached to each other and the torque limiting device is assembled, and a second step in which the torque transmission controller 6 and the flywheel 2 are centered and the torque limiting device is attached to the flywheel 2 via the torque transmission controller 6.

### BACKGROUND OF THE INVENTION

1. Field of the Invention

The present invention relates to a method of assembling a torque limiting device, and more particularly to a method of assembling a torque limiting device having a damper mechanism which is mounted to a member on the engine side thereof.

2. Background Information

There are situations in which a torque limiting device is placed between the engine and the transmission of a vehicle so that only the torque that is at or below a predetermined value is transmitted to the transmission. This torque limiting device is, for example, one in which one or more friction facings are interposed between a pair of plates and held in place with a predetermined amount of force from both sides thereof, and in which the input side thereof is connected to a flywheel or other member on the engine side and the output side thereof is connected to an input shaft of the transmission.

An example of this type of torque limiting device is shown in Japanese Unexamined Patent Application Publication No. 2002-39210. The device shown in this publication has a drive plate which includes a frictional coupling portion that is interposed between a pair of plates which apply a predetermined amount of force to the outer periphery thereof, a driven member that is connected to the input shaft of the transmission, and a spring damper that is provided therebetween. The pair of plates between which the frictional coupling member is interposed (or a damper cover that is provided on the outer periphery of the frictional coupling mechanism) is connected to a flywheel.

In this device, the engine torque is transmitted from the flywheel to the drive plate via the frictional coupling portion, and then transmitted to the driven member and the input shaft of the transmission via the spring damper. When torque that is greater than or equal to a fixed amount is input, sliding is generated in the frictional coupling portion and torque that exceeds this fixed amount will not transmitted to the transmission.

In this type of torque limiting device, the flywheel and torque limiting device must be reliably centered with respect to each other before the engine and the transmission are docked with each other, unlike when a standard clutch disk assembly used in a clutch device of a vehicle is mounted to a flywheel. This is because the frictional coupling portion of the torque limiting device must be interposed between the two plates with a predetermined amount of force and then fixed to the flywheel before the engine and the transmission are docked with each other.

Accordingly, in the torque limiting device shown in the aforementioned publication, the drive plate and the plates between which the frictional coupling portion is interposed (or the damper cover) are centered with respect to each other and assembled, and then the plates or the damper cover are/is centered with respect to the flywheel, and the torque limiting device is fixed to the flywheel.

In the aforementioned conventional torque limiting device, it is important to ensure that the drive plate and the flywheel are centered with respect to each other when assembling these items together. Generally, however, the driven member and the flywheel are not checked to determine if they are properly centered with respect to each other, even if the drive plate and the flywheel are properly centered. In other words, the driven member generally includes a tubular boss portion that is disposed in the central portion of the driven member and which is spline engaged with the input shaft of the transmission on the inner peripheral portion thereof, and a flange portion that extends from the outer periphery of the boss portion to the outer peripheral side of the driven member. A hole is formed in the inner peripheral portion of the drive plate, and the boss portion of the driven member is inserted into this hole with a gap therebetween. Due to the existence of this gap, there will be times when the centers of the drive plate and the boss portion of the driven member are out of alignment with each other. When this occurs, the centers of the flywheel and the driven member will be out of alignment with each other even if the drive plate and the flywheel are centered with respect to each other. Thus, because the input shaft of the transmission is spline engaged with the driven member, there will be problems in that the centers of the flywheel and the input shaft of the transmission will be out of alignment with each other, and the spline engagement portion will suffer from abnormal wear during use.

In view of the above, there exists a need for a method of assembling a torque limiting device which overcomes the above mentioned problems in the prior art. This invention addresses this need in the prior art as well as other needs, which will become apparent to those skilled in the art from this disclosure.

### SUMMARY OF THE INVENTION

It is therefore an object of the present invention to control abnormal wear in the portion that engages a torque limiting device having a damper mechanism with a member on the transmission side thereof.

A first aspect of the present invention is a method for assembling a torque limiting device that is to be mounted to a member on the engine side thereof, the torque limiting device having an input plate that is fixed to a frictional coupling portion on the outer periphery thereof, an output member having an engagement hole that engages with an output shaft on the inner peripheral portion thereof, a damper that elastically couples the input plate and the output member in the circumferential direction, and a torque transmission controller that is mounted to the engine side member, grasps the frictional coupling portion between a pair of plates, and controls transmitted torque.

The method of assembly includes the following steps.

In a first step, the output member and the torque transmission controller are centered with respect to each other and attached to each other, and then the torque limiting device is assembled.

In a second step, the torque transmission controller and the engine side member are centered with respect to each other, and the torque limiting device is attached to the engine side member via the torque transmission controller.

In this method, the output member and the torque transmission controller are first centered with respect to each other and attached to each other. Then, the torque transmission controller and the engine side member (e.g., the flywheel) are centered with respect to each other and attached to each other. In this way, the output member and the engine side member are centered with respect to each other and attached to each other.

Here, because a gap in the radial direction is generally present between the output member and the input plate, there will be times in which centers of the input plate and the engine side member will be out of alignment with respect to each other even if the output member is centered with respect to the engine side member. However, the most harmful effects of this misalignment will be in the portion that engages the output member with the transmission shaft, in which abnormal wear will be produced due to this misalignment.

Accordingly, in this first aspect of the present invention, the engine side member will be centered with respect to the output member by first centering the output member and the torque transmission controller with respect to each other and attaching them to each other, and then centering the torque transmission controller with respect to the engine side member with respect to each other and attaching them to each other, thereby controlling abnormal wear produced by misalignment in the portion that engages the output member with the transmission shaft.

In a second aspect of the present invention the input plate, the output member and the damper are assembled together as a damper disk device prior to the first step.

Here, the input plate, the output member and the damper are assembled together as the damper disk device prior to the first step. Thus, if the input plate and the output member are centered with respect to each other and then attached to each other, the input plate will also be centered with respect to the engine side member. In addition, the assembly in the first step will be simplified.

In a third aspect of the present invention, the input plate and the output member are centered with respect to each other and then attached to each other when the damper disk device is assembled.

Here, the input plate will also be centered with respect to the engine side member because the input plate and the output member are centered with respect to each other during the assembly of the damper disk device.

In a fourth aspect of the present invention, the torque transmission controller includes a ring-shaped cover member that is disposed on the outer peripheral side of the friction coupling portion and mounted on the engine side member, a pair of ring-shaped plates that are arranged such that the frictional coupling portion is interposed therebetween on the inner peripheral side of the cover member, and a biasing member for applying a predetermined grasping force to the pair of ring-shaped plates.

In a fifth aspect of the present invention, alignment holes are formed in the cover member along the axial direction thereof, and a jig having an axial portion that is inserted into the engagement hole of the output member and alignment pins that are inserted into alignment holes of the cover member is used to center and assemble the torque limiting device.

Here, a jig having an axial portion and alignment pins is employed, the axial portion is inserted into the engagement hole of the output member, the pins are inserted into the alignment holes of the cover member, and the output member and the cover member are centered with respect to each other thereby. Thus, alignment can be performed easily.

In a sixth aspect of the present invention, the input plate is a disk-shaped plate having holes in the inner peripheral portion thereof. In addition, both ends in the axial direction of the output member are formed into a tubular shape and one end thereof is inserted into a hole in the input plate, a bush is provided between the outer peripheral surface of the output member and the inner peripheral surface of the input plate, and the output member and the input plate are centered with respect to each other.

Here, a bush is provided in the gap in the radial direction between the input plate and the output member, and the input plate and the output member are centered with respect to each other by means of this bush.

Thus, the input plate and the output member can be easily centered with respect to each other, and misalignment between these two members can be controlled.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows a vertical schematic cross-section of a torque limiting device that includes a damper mechanism and which is employed in an embodiment of the present invention; and

FIG. 2 describes the procedure for attaching the torque limiting device depicted in FIG. 1.

### DETAILED DESCRIPTION OF THE PREFERRED EMBODIMENTS

1. Overall Configuration

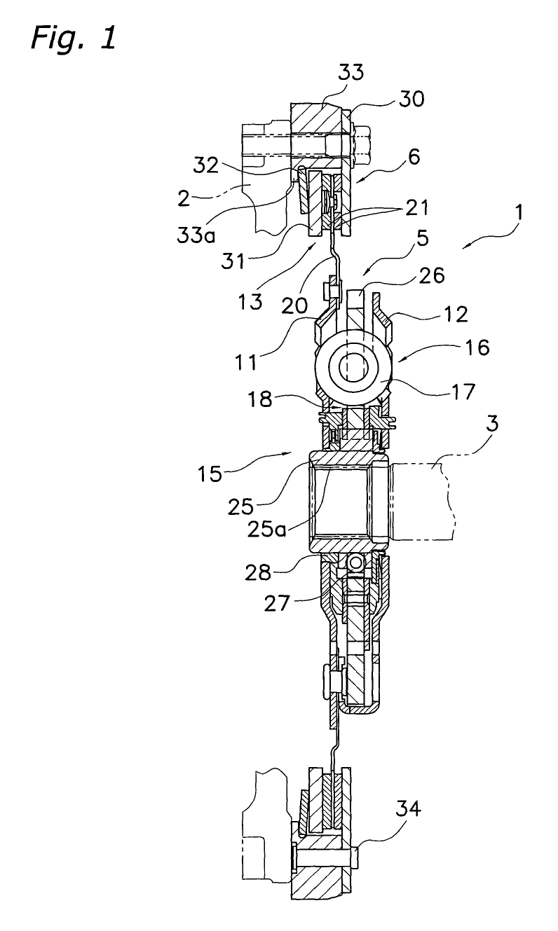

FIG. 1 shows a cross-section of a torque limiting device 1 having a damper mechanism that is employed in an embodiment of the present invention. An engine (not shown) and a flywheel 2 are disposed on the left side of FIG. 1, and a transmission (not shown) is disposed on the right side of FIG. 1.

The torque limiting device 1 is disposed between the flywheel 2 and an input shaft 3 of the transmission, and controls the torque that is transmitted from the engine to the transmission. The torque limiting device 1 includes a clutch disk assembly 5 and a torque transmission controller 6 that includes the clutch disk (frictional coupling portion) of the clutch disk assembly 5.

2. Clutch Disk Assembly

The clutch disk assembly 5 is primarily comprised of a clutch plate 11, a retaining plate 12 and a clutch disk 13 that in combination serve as an input rotary member, a spline hub 15 that serves as an output rotary member, and a damper mechanism 16 that is arranged between the input rotary member and the output rotary member.

The clutch plate 11 and the retaining plate 12 are both annular members manufactured from sheet metal, and are axially spaced from each other by a predetermined distance. The clutch plate 11 is disposed on the engine side, and the retaining plate 12 is disposed on the transmission side. The clutch plate 11 and the retaining plate 12 are fixed to each other such that they rotate together in unison. In addition, four windows are formed in the outer peripheral portions of the clutch plate 11 and the retaining plate 12 and are equidistant with respect to each other in the rotational direction. These windows support torsion springs 17 (described below). A hole is formed in the central portion of both the clutch plate 11 and the retaining plate 12.

The clutch disk 13 includes a cushioning plate 20 that is fixed to the outer peripheral portion of the clutch plate 11, and friction facings 21 that are fixed to both surfaces of the cushioning plate 20. The clutch disk 13 comprises the torque transmission controller 6 (described below).

A spline hub 15 comprises a cylindrical boss 25 that extends in the axial direction and a disk-shaped hub flange 26 that extends from the boss 25 in the radial direction. The boss 25 and the hub flange 26 are formed as separate members, and both are elastically linked in the circumferential direction in a predetermined angular range and rigidly linked in the circumferential direction in a range that exceeds the predetermined angular range. A spline hole 25a that is engaged with the input shaft 3 of the transmission is formed in the inner peripheral portion of the boss 25. A plurality of notches that are aligned in the rotational direction are formed in the hub flange 26.

In addition, both ends of the boss 25 of the spline hub 15 are inserted into the central holes in the clutch plate 11 and the retaining plate 12, and a bush 28 is disposed between the inner peripheral surface of the central hole in the clutch plate 11 and the outer peripheral surface of the boss 25.

The damper mechanism 16 serves to transmit torque between the input rotary member and the output rotary member, and absorb and attenuate torsional vibrations between the input rotary member and the output rotary member. The damper mechanism 16 includes a plurality of torsion springs 17 and hysteresis generating mechanisms 18. The plurality of torsion springs 17 are accommodated in and supported by the windows in the clutch plate 11 and the retaining plate 12 and the notches in the hub flange 26.

3. Torque Transmission Controller

The torque transmission controller 6 includes the clutch disk 13 of the clutch disk assembly 5, a first plate 30 and a second plate 31 provided such that the friction facings 21 of the clutch disk 13 are interposed therebetween in the axial direction, a cone spring 32 that applies a grasping force to the first plate 30 and the second plate 31, and a ring-shaped cover member 33 that is disposed on the outer peripheral side of the clutch disk 13.

The first plate 30 is fixed to the lateral surface of the cover member 33 on the transmission side thereof by means of rivets 34. A annular engagement projection 33a that projects toward the inner periphery is formed on the edge of the inner peripheral portion of the cover member 33 on the engine side thereof. In the inner peripheral portion of the cover member 33, the second plate 31 is disposed such that the friction facings 21 are interposed between the first plate 30, and the cone spring 32 is compressed and disposed between the second plate 31 and the engagement projection 33a. With this configuration, the amount of torque capable of being transmitted is determined by means of the biasing force from the cone spring 32, the coefficient of friction of the friction facings 21, and the effective radius of the portions undergoing friction. When torque that exceeds the amount of torque capable of being transmitted is input from the engine side, sliding is produced in the portions undergoing friction and thus the amount of torque actually transmitted is limited to the amount of torque capable of being transmitted.

4. Method of Assembly

The sequence in which the torque limiting device 1 having the aforementioned structure is installed onto the flywheel will be described below.

First, the clutch disk assembly 5 will be assembled. There is no difference between how this clutch disk assembly 5 is assembled and how a conventional clutch disk assembly is assembled, and thus a detailed description of this will be omitted. Note that when this clutch disk assembly 5 is assembled, the bush 28 is provided between the central hole of the clutch plate 11 and the boss 25 of the spline hub 15. Thus, the clutch plate 11 and the spline hub 15 are centered with respect to each other by means of the bush 28, thereby allowing simple and accurate centering and assembly to be performed. Moreover, the bush 28 can prevent the centers of the clutch plate 11 and the spline hub 15 (particularly the boss 25) from slipping out of alignment with respect to each other.

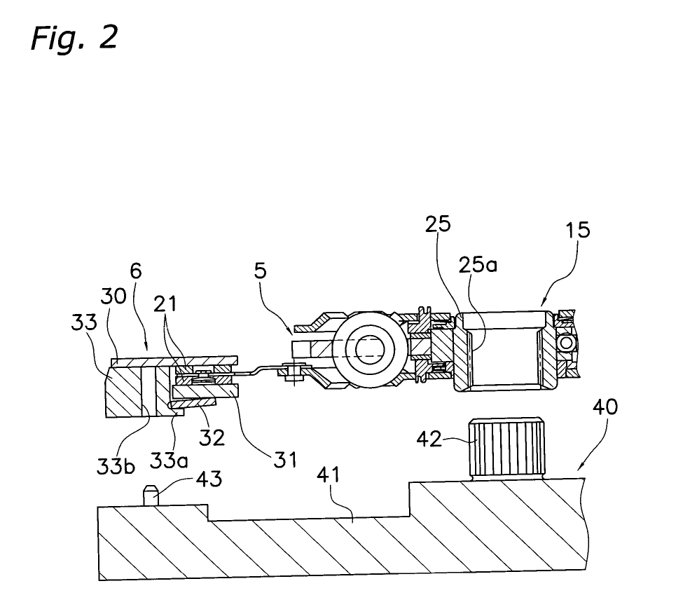

Next, a jig 40 shown in FIG. 2 is employed to center and assemble the clutch disk assembly 5 and the torque transmission controller 6.

The jig 40 includes a disk-shaped jig unit 41, a spline shaft 42, and two knock pins 43. The spline shaft 42 projects out from the central portion of the surface of the jig unit 41, and can engage with the spline hole 25a in the spline hub 15 of the clutch disk assembly 5. In addition, the two knock pins 43 are arranged such that they project out from the outer peripheral portion of the surface of the jig unit 41, and can engage with knock holes 33b formed in the cover member 33 along the axial direction.

When the jig 40 is used to perform centering and assembly, the knock pins 43 of the jig 40 are aligned with the knock holes 33b of the cover member 33, and then the knock pins 43 are inserted into the holes 33b while setting the cover member 33 onto the jig 40. Note that the rivets 43 are set into the cover member 33 when this is performed.

Next, the cone spring 32 and the second plate 31 are set into the inner peripheral portion of the cover member 33, and the clutch disk assembly 5 is mounted thereon. The clutch disk assembly 5 is mounted thereon while the spline shaft 42 of the jig 40 is inserted into the spline hole 25a of the spline hub 15. In this way, the spline hub 15 and the torque transmission controller 6 (cover member 33) are centered with respect to each other. As noted above, the clutch plate 11 and the cover member 33 are also centered with respect to each other because the clutch plate 11 and the spline hub 15 are centered with respect to each other and attached to each other when the clutch disk assembly 5 is assembled.

In this state, the clutch disk assembly 5 and the torque transmission controller 6 are attached to each other by placing the first plate 30 into position and fixing it thereto with the rivets 34.

Next, the torque limiting device 1 assembled in the manner described above is placed onto the flywheel 2 whilst the knock pins (not shown in the figures) provided on the flywheel 2 are inserted into the knock holes 33b of the cover member 33. Then, bolts are passed through bolt holes formed in the first plate 30 and the cover member 33, and the torque limiting device is attached to the flywheel 2.

In this way, the flywheel 2 and the spline hub 15 of the torque limiting device 1 can be centered with respect to each other and then attached to each other. Thus, abnormal contact with the spline engagement portion due to misalignment can be avoided, and abnormal wear of the spline engagement portion can be controlled thereby.

It should be noted that the structure of the clutch disk assembly described in the aforementioned embodiment is not limited thereto, and various other types of clutch disk assemblies can be used in the present invention.

Likewise, the structure of the torque transmission controller described in the aforementioned embodiment is not limited thereto.

When the torque limiting device having a damper mechanism according to the present invention is attached to the engine side member, the engine side member can be prevented from coming out of alignment with respect to the torque limiting device and in particular the driven member, and thus abnormal wear in the portion that engages the output portion of the torque limiting device with the transmission can be controlled.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application No. 2002-259546. The entire disclosure of Japanese Patent Application No. 2002-259546 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A method for assembling a torque limiting device having a damper mechanism to be mounted to a member on the engine side thereof, the torque limiting device having an input plate that is fixed to a frictional coupling portion on the outer periphery of the input plate, an output member having an engagement hole that engages with an output shaft on the inner peripheral portion thereof, a damper that elastically couples the input plate and the output member in the circumferential direction, and a torque transmission controller that is mounted to the engine side member, grasps the frictional coupling portion between a pair of plates, and controls transmitted torque, the method comprising the steps of:
a first step in which the output member and the torque transmission controller are centered with respect to each other and attached to each other, and the torque limiting device is then assembled; and
a second step in which the torque transmission controller and the engine side member are centered with respect to each other, and the torque limiting device is attached to the engine side member via the torque transmission controller.

2. The method of assembling the torque limiting device having a damper mechanism according to claim 1, wherein the input plate, the output member, and the damper are assembled together as a damper disk device prior to the first step.

3. The method of assembling the torque limiting device having a damper mechanism according to claim 2, wherein the input plate and the output member are centered and assembled together when the damper disk device is assembled.

4. The method of assembling a torque limiting device having a damper mechanism disclosed in claim 3, wherein the torque transmission controller includes:
a ring-shaped cover member that is disposed on the outer peripheral side of the friction coupling portion and mounted to the engine side member;
a pair of ring-shaped plates that are arranged such that the frictional coupling portion is interposed therebetween on an inner peripheral side of the cover member; and
a biasing member for applying a predetermined grasping force to the pair of ring-shaped plates.

5. The method of assembling a torque limiting device having a damper mechanism disclosed in claim 4, wherein alignment holes are formed in the cover member along the axial direction; and
in the first step, a jig is used to center and assemble the torque limiting device, the jig having an axial portion that is inserted into an engagement hole of the output member, and alignment pins that are inserted into alignment holes of the cover member.

6. The method of assembling a torque limiting device having a damper mechanism disclosed in any of claims 3 to 5, wherein the input plate is a disk-shaped plate having holes in the inner peripheral portion thereof;
both ends of the output member in the axial direction are formed into a tubular shape, and one end thereof is inserted into a hole in the input plate; and a bush is provided between the outer peripheral surface of the output member and the inner peripheral surface of the input plate, and the output member and the input plate are centered with respect to each other.
